(19) United States
(12) Patent Application Publication
(10) Pub. No.: US 2004/0163504 A1
(43) Pub. Date: Aug. 26, 2004

(54) Wrench

(76) Inventor: Terence Chen, Lo Tung Town (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/374,476

(22) Filed: Feb. 24, 2003

(51) Int. Cl. B25B 13/00

(52) U.S. Cl. 81/186

(57) ABSTRACT

A wrench is provided for driving an object formed with a plurality of facets and a plurality of corners. The wrench includes a head and a handle extending from the head. The head includes two jaws and a throat formed between the jaws. Each of the jaws includes a convex face formed on an internal side thereof for contact with one of the facets of the object. The throat includes two convex faces formed on an internal side thereof each for contact with one of the facets of the object. A recess is defined between each of the convex faces and one of the convex faces. A recess is defined between the convex faces. Each of the recesses receives one of the corners of the object. The recesses may be rounded.

### BACKGROUND OF INVENTION

1. Field of Invention

The present invention relates to a wrench.

2. Related Prior Art

Referring to FIG. 5, a conventional wrench 1 includes a head 2 and a handle (not numbered) extending from the head 2. The head 2 includes two jaws 3 and a throat 4 formed between the jaws 3. Between the jaws 3 is defined a space 5 for receiving a nut or bolt head 8. Each of the jaws 3 includes an internal face parallel to that of the other one of the jaws 3. The throat 4 includes an arched internal face 7. The bolt head 8 includes six facets (not numbered) and six corners 9. It is intended that the internal faces of the jaws 3 contact two of the facets of the bolt head 8, however, the internal faces of the jaws 3 actually contact two of the corners of the bolt head 8. The total area of contact of the internal faces of the jaws 3 with the corners of the bolt head 8 is small. When a great torque is exerted on the bolt head 8 via the wrench 1, the two of the corners 9 of the bolt head 8 will be damaged, worn or rounded. Thus, a user can no longer drive the bolt head 8 adequately by means of the wrench 1.

The present invention is therefore intended to obviate or at least alleviate the problems encountered in prior art.

### SUMMARY OF INVENTION

It is the primary objective of the present invention to provide an anti-slippery wrench.

According to the present invention, a wrench is provided for driving an object formed with a plurality of facets and a plurality of corners. The wrench includes a head and a handle extending from the head. The head includes two jaws and a throat formed between the jaws. Each of the jaws includes a convex face formed on an internal side thereof for contact with one of the facets of the object. The throat includes two convex faces formed on an internal side thereof each for contact with one of the facets of the object. A recess is defined between each of the convex faces and one of the convex faces. A recess is defined between the convex faces. Each of the recesses receives one of the corners of the object.

The recesses may be rounded.

Other objects, advantages, and novel features of the invention will become more apparent from the following detailed description when taken in conjunction with the attached drawings.

### BRIEF DESCRIPTION OF DRAWINGS

The present invention will be described through detailed illustration of embodiments referring to the attached drawings wherein:

FIG. 1 is a top view of a wrench according to the preferred embodiment of the present invention.

FIG. 2 is similar to FIG. 1 but showing a bolt head engaged with the wrench.

FIG. 3 is similar to FIG. 2 but showing the bolt head driven in an angular direction by means of the wrench.

FIG. 4 is similar to FIG. 3 but showing the bolt head driven in an opposite angular direction by means of the wrench.

FIG. 5 is a top view of a conventional wrench.

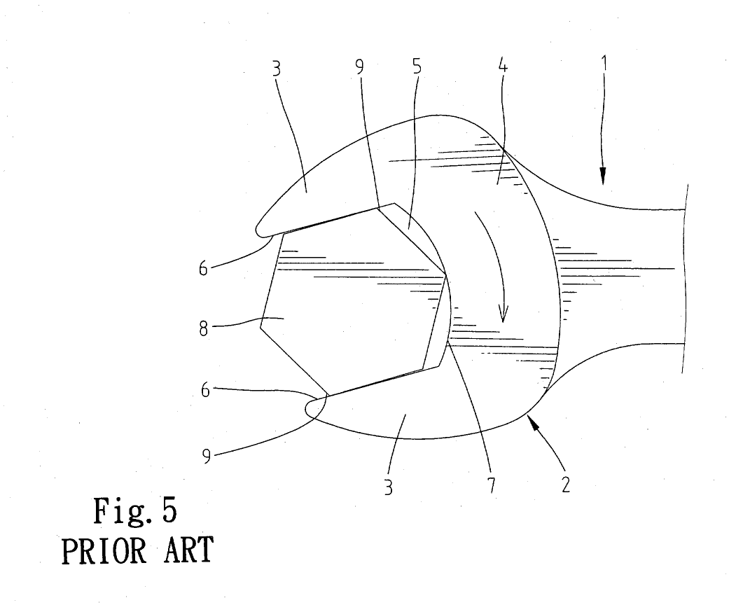

### DETAILED DESCRIPTION OF PREFERRED EMBODIMENT

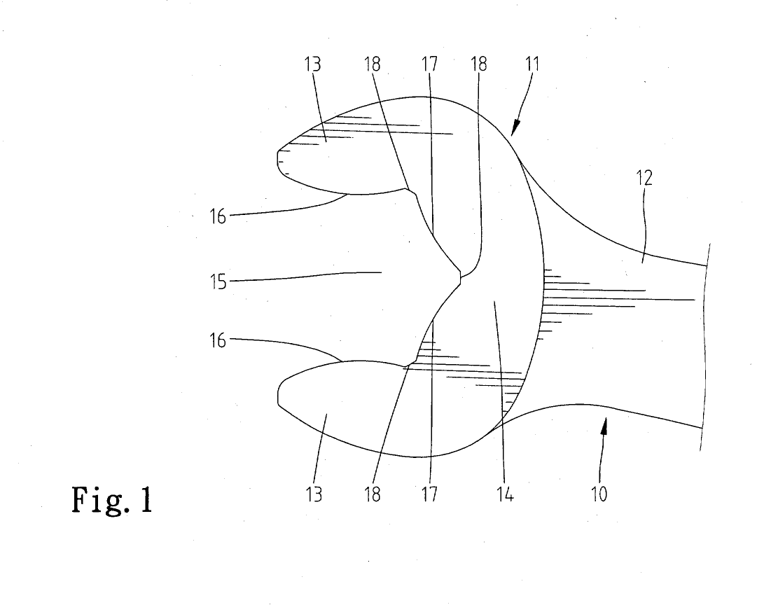

Referring to FIG. 1, according of the preferred embodiment of the present invention, a wrench 10 includes a head 11 and a handle 12 extending from the head 11. The head 11 includes two jaws 13 and a throat 14 formed between the jaws 13. Between the jaws 13 is defined a space 15 for receiving a bolt head 20. Each of the jaws 13 includes a convex face 16 formed on an internal side thereof. The throat 14 includes two convex faces 17 formed on an internal side thereof. A recess 18 is defined between each of the convex faces 16 and one of the convex faces 17. A recess 18 is defined between the convex faces 17.

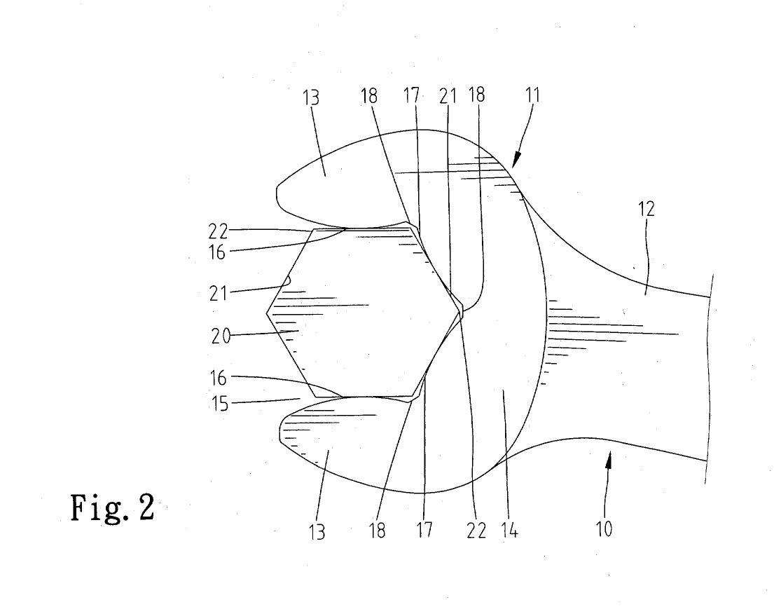

Referring to FIG. 2, the bolt head 20 is engaged with the head 11. The bolt head 20 includes six facets 21 and six corners 22. Each of the convex faces 16 and 17 contacts one of the facets 21. Each of the recesses 18 receives one of the corners 22. The convex faces 16 actually contact two of the facets 21. The recesses 18 render it possible to avoid damaging the corners 22. The recesses 18 are rounded for avoiding becoming weak points of the head 11.

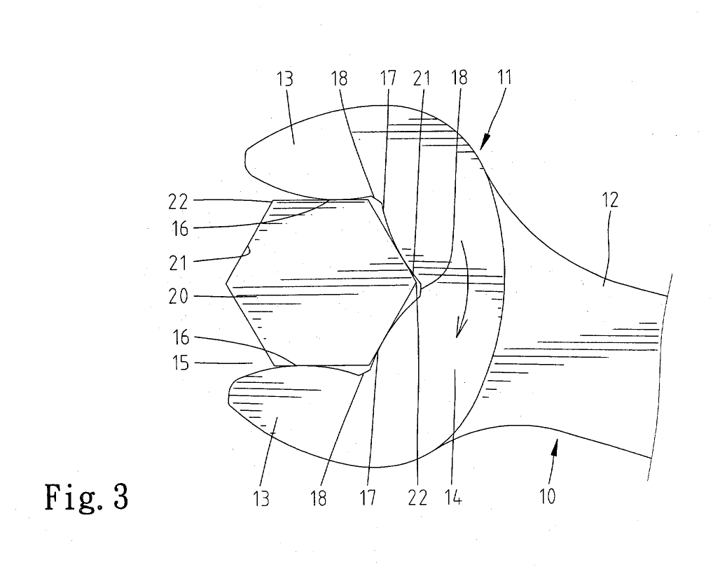

Referring to FIG. 3, the bolt head 20 is driven clockwise by means of the wrench 10. The head 11 is rotated clockwise relative to the bolt head 20 by a small angle. Each of the convex faces 16 and 17 still contacts one of the facets 21. Each of the recesses 18 still receives one of the corners 22.

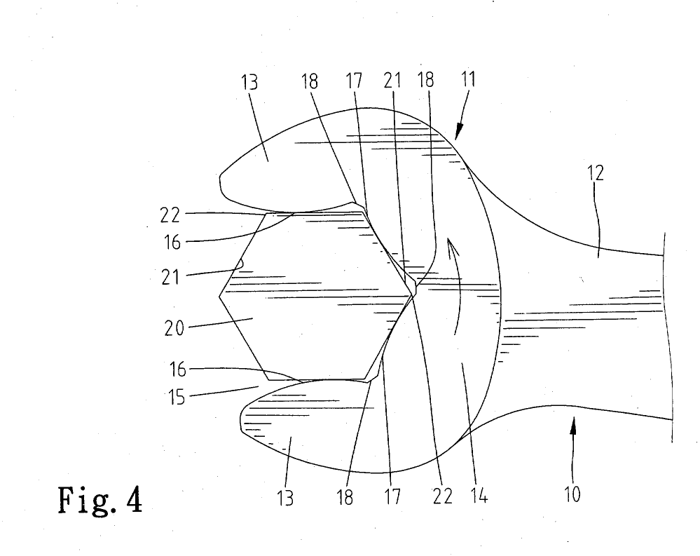

Referring to FIG. 4, the bolt head 20 is driven counterclockwise by means of the wrench 10. The head 11 is rotated counterclockwise relative to the bolt head 20 by a small angle. Each of the convex faces 16 and 17 still contacts one of the facets 21. Each of the recesses 18 still receives one of the corners 22.

As clearly shown in FIGS. 3 and 4, the total area of contact of the convex faces 16 and 17 with four of the facets 21 is large compared with that is with the conventional wrench described in Related Prior Art of this specification. Therefore, a user can exert a greater torque on a bolt head with the wrench 10 of the present invention than with the conventional wrench 1 described in Related Prior Art of this specification.

The present invention has been described through detailed illustration of the preferred embodiment. Those skilled in the art can derive variations from the preferred embodiment without departing from the scope of the present invention. Therefore, the preferred embodiment shall not limit the scope of the present invention defined in the claims.

What is claimed is:

1. A wrench for driving an object formed with a plurality of facets and a plurality of corners, the wrench including:
a head including two jaws and a throat formed between the jaws, each of the jaws including a convex face formed on an internal side thereof for contact with one of the facets of the object, the throat includes two convex faces formed on an internal side thereof each for contact with one of the facets of the object, a recess being defined between each of the convex faces and one of the convex faces, a recess being defined between the convex faces, each of the recesses receiving one of the corners of the object; and
a handle extending from the head.

2. The according to claim 1 wherein the recesses are rounded.
